(19) United States
(12) Patent Application Publication
(10) Pub. No.: US 2022/0348708 A1
(43) Pub. Date: Nov. 3, 2022

(54) METHOD FOR PRODUCING ISOCYANURATES FROM URETDIONES

(71) Applicant: COVESTRO INTELLECTUAL PROPERTY GMBH & CO. KG, LEVERKUSEN (DE)

(72) Inventors: Hans-Josef Laas, Odenthal (DE); Florian Stempfle, Köln (DE); Kai Laemmerhold, Odenthal (DE); Saskia Beuck, Leverkusen (DE); Raul Pires, Köln (DE); Christoph Guertler, Köln (DE); Nusret Yuva, Burscheid (DE); Ralph-Georg Born, Remscheid (DE); Daniel Thiel, Leverkusen (DE); Tuba Fatma Bayram, Aachen (DE); Sureshbabu Guduguntla, Turnhout (BE); Walter Leitner, Aachen (DE)

(21) Appl. No.: 17/624,883

(22) PCT Filed: Jul. 6, 2020
(86) PCT No.: PCT/EP2020/068924

§ 371 Date: Jan. 5, 2022

(30) Foreign Application Priority Data
Jul. 11, 2019 (EP) 19185845.5

(51) Int. Cl. C08G 18/02; C08G 18/20; C08G 18/28; C08G 18/79; C09D 175/04

(52) U.S. Cl. CPC C08G 18/022; C08G 18/027; C08G 18/2027; C08G 18/282; C08G 18/2865; C08G 18/798; C08G 18/791; C09D 175/04; C08G 2115/02; C08G 2150/00

(57) ABSTRACT

The invention relates to a process of preparing allophanate- and/or thioallophanate group-containing compounds comprising the following steps: reacting A) at least one component having at least one uretdione group with B) at least one component having at least one hydroxyl and/or thiol group, in the presence C) of at least one catalyst, containing a structural element of the general formulae (I) and/or (II), wherein R1, R2, R3, R4, R5 and R6 independently of each other represent the same or different radicals meaning saturated or unsaturated, linear or branched, aliphatic, cycloaliphatic, araliphatic or aromatic organic radicals with 1 to 18 carbon atoms that are substituted or unsubstituted and/or have heteroatoms in the chain, the radicals being capable of forming, even when combined with each other and optionally together with an additional heteroatom, rings with 3 to 8 carbon atoms that can optionally be further substituted, wherein R3, R4, R5 and R6 independently of each other also can represent hydrogen, and R7 represents hydrogen or a carboxylate anion (COO—), the at least one component A) having at least one uretdione group being polyaddition compounds A2) that can be obtained by reacting isocyanate-functional uretdione groups A1) with alcohols and/or amines that have a free isocyanate group content of less than 5 wt. % in their solvent-free form.

The present invention relates to a process for producing isocyanurate-containing compounds, to compositions containing such compounds and to the use of these compositions for producing polyurethane plastics or coating formulations. The invention further relates to coating formulations containing the compositions and to substrates coated with the coating formulation. The invention further relates to shaped articles made of the polyurethane plastic.

Isocyanurate structures have a special status among the possible reaction products of the isocyanate group. Compared to other isocyanate reaction products such as for example biuret, uretdione, urethane or allophanate structures they are markedly more resistant to hydrolysis and heat for example. Production of isocyanurates is generally effected by catalytic trimerization of isocyanates. A multiplicity of processes differing in particular in terms of the employed trimerization catalysts has been developed in the past.

Known trimerization catalysts are, for example, tertiary amines or phosphines, tertiary hydroxyalkylamines (GB 2 221 465), mixtures of tertiary bicyclic amines with simple low molecular weight aliphatic alcohols (GB 2 222 161), organometallic compounds (DE-A 3 240 613), alkali metal and alkaline earth salts of carboxylic acids (DE-A 3 219 608, EP-A 0 100 129), alkali metal phenoxides (GB-PS 1 391 066, GB-PS 1 386 399), alkali metal and alkaline earth metal oxides, hydroxides, carbonates, alkoxides and phenoxides (GB 809 809), basic alkali metal compounds complexed with crown ethers or polyether alcohols (EP-A 0 056 158, EP-A 0 056 159), pyrrolidinone potassium salt (EP-A 0 033 581), quaternary ammonium hydroxides (DE-A 1 667 309, EP-A 0 013 880, EP-A 0 047 452), quaternary hydroxyalkylammonium hydroxides (EP-A 37 65, EP-A 10 589), trialkylhydroxylalkylammonium carboxylates (DE-A 2631733, EP-A 0 671 426, EP-A 1 599 526, U.S. Pat. No. 4,789,705), quaternary benzylammonium carboxylates (EP-A 1 229 016), tetrasubstituted ammonium-ahydroxycarboxylates (WO 2005/087828), quaternary ammonium or phosphonium fluorides (EP-A 0 339 396, EP-A 0 379 914, EP-A 0 443 167), quaternary ammonium and phosphonium polyfluorides (EP-A 0 798 299, EP-A 0 896 009, EP-A 0 962 455), tetraalkylammonium alkyl carbonates (EP-A 0 668 271), quaternary ammonium hydrogencarbonates (WO 1999/023128), quaternary ammonium salts (EP 0 102 482) obtained from tertiary amines and alkylating esters of acids of phosphorus or tetrasubstituted ammonium salts of lactams (WO 2013/167404).

Compounds having an imidazolium salt structure have likewise already found use as catalysts for trimerization of isocyanate groups. For example, the use of catalysts containing imidazolium or imidazolinium cations makes it possible to trimerize preferably aromatic monomeric diisocyanates but also oligomeric polyisocyanates, such as dimers or prepolymers, to afford polyisocyanurates or polyisocyanurate/polyurethanes (WO 2010/054317, WO 2014/160616, WO 2015/006391).

Imidazolium or imidazolinium salts moreover also catalyze the reaction of aromatic epoxides with aromatic isocyanates to afford oxazolidinone- and isocyanurate-containing plastics (WO 2016/102359).

WO 2005/113626 teaches that N-heterocyclic carbenes (NHC), for example those having an imidazolium or imidazolinium structure, are excellent catalysts for producing uretdione and/or isocyanurate polyisocyanates from any desired monomeric mono-, di- and triisocyanates. Both the free N-heterocyclic carbenes and their adducts with carbon dioxide, so-called imidazolium or imidazolinium carboxylates, may be employed. Depending on the type of the employed isocyanate and the employed catalyst the process provides uretdiones or isocyanurates, often also obtained as a mixture, even at low temperatures.

Eur. J. Inorg. Chem. 2009, 1970-1976 describes adducts of N-heterocyclic carbenes having an imidazolium or imidazolinium structure with carbon dioxide, magnesium, aluminum and zinc as catalysts for the synthesis of polyurethanes and also for the trimerization of isocyanate groups.

In all known prior art processes for producing isocyanurates the starting compounds used are always those comprising free isocyanate groups, in particular monomeric diisocyanates. Isocyanate-functional compounds are generally classified however as health-hazardous, sensitizing or even toxic substances which in some cases also have a high vapor pressure.

The processing of compounds having free isocyanate groups, in particular monomeric diisocyanates, therefore requires a great deal of safety engineering for reasons of occupational hygiene.

As has now been found, surprisingly, uretdione groups present in compounds free from isocyanate groups may in the presence of catalysts having an imidazolium or dihydroimidazolium cation be converted directly into isocyanurate structures without intermediate occurrence of free isocyanate groups.

This direct reaction of uretdione structures to isocyanurate structures was hitherto unknown. Said reaction makes it possible for the first time to synthesize polyurethanes crosslinked via isocyanurate groups starting from polyuretdione systems which are substantially free from isocyanate groups and are physiologically unconcerning.

The present invention provides a process for producing isocyanurate-containing compounds comprising reaction of
A) at least one substantially isocyanate-free component comprising at least one uretdione group in the presence of
B) at least one catalyst containing a structural element of general formulae (I) and/or (II)

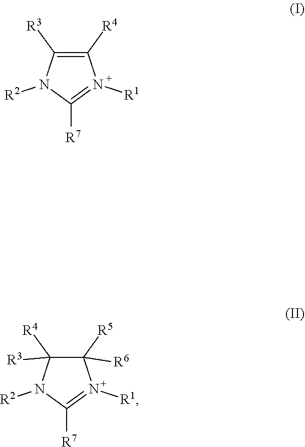

in which
R¹, R², R³, R⁴, R⁵ and R⁶ independently of one another stand for identical or different radicals which represent saturated or unsaturated, linear or branched, aliphatic, cycloaliphatic, araliphatic or aromatic organic radicals having 1 to 18 carbon atoms which are substituted or unsubstituted and/or have heteroatoms in the chain, wherein the radicals may also in combination with one another optionally together with a further heteroatom form rings having 3 to 8 carbon atoms which may optionally be further substituted, wherein
R³, R⁴, R⁵ and R⁶ may independently of one another also represent hydrogen and
R⁷ represents hydrogen or a carbon/late anion (COO⁻).

According to the invention, the references to “comprising”, “containing”, etc., preferably denote “substantially consisting of” and very particularly preferably denote “consisting of”. The further embodiments identified in the claims and in the description can be combined arbitrarily, provided the context does not clearly indicate that the opposite is the case.

The uretdione-containing component A) is any desired uretdione-containing compounds which are substantially free from isocyanate groups, as are obtainable by methods known per se. In a first preferred embodiment, component A) is polyaddition compounds obtainable by oligomerization of monomeric isocyanates and/or by reaction of isocyanate-functional uretdione-containing compounds with alcohols and/or amines.

Starting compounds for producing the uretdione-comprising component A) are any mono-, di-, and triisocyanates having aliphatically, cycloaliphatically, araliphatically and/or aromatically bonded isocyanate groups obtainable in various ways, for example by phosgenation in the liquid or gas phase or by a phosgene-free route, for example by thermal urethane cleavage.

Preferred monoisocyanates are those in the molecular weight range 99 to 300, for example n-butyl isocyanate, n-amyl isocyanate, n-hexyl isocyanate, n-heptyl isocyanate, n-octyl isocyanate, undecyl isocyanate, dodecyl isocyanate, tetradecyl isocyanate, cetyl isocyanate, stearyl isocyanate, cyclopentyl isocyanate, cyclohexyl isocyanate, 3- and 4-methylcyclohexyl isocyanate, benzyl isocyanate, phenyl isocyanate or naphthyl isocyanate.

Preferred diisocyanates are those in the molecular weight range 140 to 400, for example 1,4-diisocyanatobutane, 1,5-diisocyanatopentane (pentamethylene diisocyanate, PDI), 1,6-diisocyanatohexane (hexamethylene diisocyanate, HDI), 2-methyl-1,5-diisocyanatopentane, 1,5-diisocyanato-2,2-dimethylpentane, 2,2,4- and 2,4,4-trimethyl-1,6-diisocyanatohexane, 1,10-diisocyanatodecane, 1,3- and 1,4-diisocyanatocyclohexane, 1,3-and 1,4-bis(isocyanatomethyl)cyclohexane, 1,3-diisocyanato-2(4)-methylcyclohexane, 1-isocyanato-3,3,5-trimethyl-5-isocyanatomethylcyclohexane (isophorone diisocyanate, IPDI), 2,4′- and 4,4′-diisocyanatodicyclohexylmethane (H₁₂-MDI), 4,4′-diisocyanato-3,3′-dimethyldicyclohexyl)methane, 4,4′-diisocyanato-3,3′,5,5′-tetramethyldicyclohexylmethane, 4,4′-diisocyanato-1,1′-bicyclohexyl, 4,4′-diisocyanato-3,3′-dimethyl-1,1′-bicyclohexyl, 4,4′-diisocyanato-2,2′,5,5′-tetramethyl-1,1′-bicyclohexyl, 1,8-diisocyanato-p-menthane, 1,3-diisocyanatoadamantane, 1,3-dimethyl-5,7-diisocyanatoadamantane, 1-isocyanato-1-methyl-4(3)-isocyanatomethylcyclohexane, bis(isocyanatomethyl)norbornane (NBDI), 1,3-and 1,4-bis(isocyanatomethyl)benzene (xylylene diisocyanate, XDI), 1,3- and 1,4-bis(2-isocyanatopropan-2-yl)benzene (tetramethylxylylene diisocyanate, TMXDI), 1,3-bis(isocyanatomethyl)-4-methylbenzene, 1,3-bis(isocyanatomethyl)-4-ethylbenzene, 1,3-bis(isocyanatomethyl)-5-methylbenzene, 1,3-bis(isocyanatomethyl)-4,5-dimethylbenzene, 1,4-bis(isocyanatomethyl)-2,5-dimethylbenzene, 1,4-bis(isocyanatomethyl)-2,3,5,6-tetramethylbenzene, 1,3-bis(isocyanatomethyl)-5-tert-butylbenzene, 1,3-bis(isocyanatomethyl)-4-chlorobenzene, 1,3-bis(isocyanatomethyl)-4,5-dichlorobenzene, 1,3-bis(isocyanatomethyl)-2,4,5,6-tetrachlorobenzene, 1,4-bis(isocyanatomethyl)-2,3,5,6-tetrachlorobenzene, 1,4-bis(isocyanatomethyl)-2,3,5,6-tetrabromobenzene, 1,4-bis(2-isocyanatoethyl)benzene and 1,4-bis(isocyanatomethyl)naphthalene, 1,2-, 1,3-, and 1,4-diisocyanatobenzene (phenylene diisocyanate), 2,4- and 2,6-diisocyanatotoluene (tolylene diisocyanate, TDI), 2,3,5,6-tetramethyl-1,4-diisocyanatobenzene, the isomeric diethylphenylene diisocyanates, diisopropylphenylene diisocyanates, diisododecylphenylene diisocyanates, and biphenyl diisocyanates, 3,3′-dimethoxybiphenyl 4,4′-diisocyanate, 2,2′-, 2,4′- and 4,4′-diisocyanatodiphenylmethane (MDI), 3,3′-dimethyldiphenylmethane 4,4′-diisocyanate, 4,4′-diisocyanatodiphenylethane, 1,5-diisocyanatonaphthalene (naphthylene diisocyanate, NDI), diphenyl ether diisocyanate, ethylene glycol diphenyl ether diisocyanate, diethylene glycol diphenyl ether diisocyanate, 1,3-propylene glycol diphenyl ether diisocyanate, benzophenone diisocyanate, triisocyanatobenzene, 2,4,6-triisocyanatotoluene, trimethylbenzene triisocyanate, diphenylmethane 2,4,4′-triisocyanate, 3-methyldiphenylmethane 4,6,4′-triisocyanate, the isomeric naphthalene triisocyanates and methylnaphthalene diisocyanates, triphenylmethane triisocyanate or 2,4-diisocyanato-1-[(5-isocyanato-2-methylphenyl)methyl]benzene.

Further diisocyanates that are likewise suitable may additionally be found for example in Justus Liebigs Annalen der Chemie, volume 562 (1949) pp. 75-136.

An example of a particularly suitable triisocyanate is 4-isocyanatomethyloctane 1,8-diisocyanate (triisocyanatononane; TIN).

Also employable as starting compounds for producing the uretdione-comprising component A) are mixtures of at least two such mono-, di-, and/or triisocyanates.

Preferably employed as starting compounds for producing the uretdione-comprising component A) are monomeric diisocyanates.

It is particularly preferable to employ PDI, HDI, IPDI, NBDI, XDI and/or H₁₂-MDI and very particularly preferable to employ PDI and/or HDI. Thus in a further preferred embodiment component A) is uretdione-containing compounds based on PDI, HDI, IPDI, NBDI, XDI and/or H₁₂-MDI.

The production of the uretdione-containing component A) or the starting compounds for the preparation thereof may be carried out by various methods which are generally based on the customary processes known from the literature for oligomerization of simple diisocyanates, as described for example in J. Prakt. Chem. 336 (1994) 185-200, DE-A 16 70 666, DE-A 19 54 093, DE-A 24 14 413, DE-A 24 52 532, DE-A 26 41 380, DE-A 37 00 209, DE-A 39 00 053, DE-A 39 28 503, EP-A 336 205, EP-A 339 396 and EP-A 798 299.

In the case of exclusive use or partial co-use of monoisocyanates the uretdione-comprising components A) may be present in isocyanate-free form immediately after the oligomerization reaction. However, the oligomerization reaction preferably also employs at least di- and/or triisocyanates in amounts such that it initially affords compounds containing isocyanate-functional uretdione groups having an average NCO functionality of at least 1.6, preferably of 1.8 to 3.5, particularly preferably of 1.9 to 3.2, very particularly preferably of 2.0 to 2.7.

At average NCO functionalities of >2.0 these compounds containing isocyanate-functional uretdione groups contain not only linear difunctional uretdione structures but also further, at least trifunctional, polyisocyanate molecules. These higher functional constituents of the uretdione-containing compounds are in particular the known reaction products of diisocyanates with an isocyanurate, allophanate, biuret, urethane and/or iminooxadiazinedione structure.

The compounds containing uretdione groups obtained by oligomerization are generally freed of the unreacted excess monomer immediately after their above-described production from simple monomeric mono-, di- and/or triisocyanates by known methods, for example by thin-film distillation or extraction. In a preferred embodiment said compounds therefore have residual contents of monomeric diisocyanates of less than 5% by weight, preferably less than 2% by weight, particularly preferably less than 1% by weight.

In the event that the oligomerization reaction does not afford a component A) comprising isocyanate-free uretdione groups but rather isocyanate-functional uretdione-containing compounds these latter compounds are reacted with alcohols and/or amines to afford substantially isocyanate-free, uretdione-containing polyaddition compounds A).

Suitable alcohols for producing the polyaddition compounds A) are for example simple aliphatic or cycloaliphatic monoalcohols, such as methanol, ethanol, n-propanol, isopropanol, n-butanol, isobutanol, sec-butanol, the isomeric pentanols, hexanols, octanols, and nonanols, n-decanol, n-dodecanol, n-tetradecanol, n-hexadecanol, n-octadecanol, cyclohexanol, the isomeric methylcyclohexanols and hydroxymethylcyclohexane, ether alcohols such as 2-methoxyethanol, 2-ethoxyethanol, 2-propoxyethanol, 2-butoxyethanol, diethylene glycol monomethyl ether, diethylene glycol monoethyl ether, diethylene glycol monobutyl ether, 3-methoxy-1-butanol and glycerol 1,3-diethyl ether, ester alcohols, such as hydroxyethyl acetate, butyl glycolate, ethyl lactate, glycerol diacetate or those such as can be obtained by reacting the recited monoalcohols with lactones, or ether alcohols such as can be obtained by reacting the recited monoalcohols with alkylene oxides, in particular ethylene oxide and/or propylene oxide.

Alcohols likewise suitable for producing the substantially isocyanate-free, uretdione-containing polyaddition compounds A) include any at least difunctional polyols in the molecular weight range 62 to 22 000, preferably those having an average functionality of 2 to 6 and a number average molecular weight of 62 to 18 000, particularly preferably an average functionality of 2 to 4 and a number average molecular weight of 90 to 12 000.

Suitable polyols for producing the substantially isocyanate-free uretdione-containing polyaddition compounds A) are for example simple polyhydric alcohols having 2 to 14, preferably 4 to 10, carbon atoms, for example ethane-1,2-diol, propane-1,2-diol and -1,3-diol, the isomeric butanediols, pentanediols, hexanediols, heptanediols and octanediols, decane-1,10-diol, dodecane-1,12-diol, cyclohexane-1,2-diol and -1,4-diol, cyclohexane-1,4-dimethanol, 1,4-bis(2-hydroxyethoxy)benzene, 2,2-bis(4-hydroxyphenyl)propane (bisphenol A), 2,2-bis(4-hydroxycyclohexyl)propane (perhydrobisphenol), propane-1,2,3-triol, butane-1,2,4-triol, 1,1,1-trimethylolethane, hexane-1,2,6-triol, 1,1,1-trimethylolpropane (TMP), bis(2-hydroxyethyl)hydroquinone, 1,2,4- and 1,3,5-trihydroxycyclohexane, 1,3,5-tris(2-hydroxyethyl)isocyanurate, 3(4),8(9)-bis(hydroxymethyl)-tricyclo-[5.2.1.0^{2,6}]decane, di-trimethylolpropane, 2,2-bis(hydroxymethyl)propane-1,3-diol (pentaerythritol), 2,2,6,6-tetrakis(hydroxymethyl)-4-oxaheptane-1,7-diol (dipentaerythritol), mannitol or sorbitol, low-molecular-weight ether alcohols, for example diethylene glycol, triethylene glycol, tetraethylene glycol, dipropylene glycol or dibutylene glycol, or low-molecular-weight ester alcohols, for example neopentyl glycol hydroxypivalate.

Suitable polyols for producing the substantially isocyanate-free, uretdione-containing polyaddition compounds A) also include the customary polymeric polyether polyols, polyester polyols, polycarbonate polyols, and/or polyacrylate polyols known from polyurethane chemistry, which typically have a number-average molecular weight of 200 to 22 000, preferably of 250 to 18 000, particularly preferably of 250 to 12 000. A broad overview of suitable polymeric polyols for producing the polyaddition compounds A2) may be found for example in N. Adam et al. Polyurethanes. In: Ullmann's Encyclopedia of Industrial Chemistry, Wiley-VCH Verlag GmbH & Co. KgaA; 2005. URL: https://doi.org/10.1002/14356007.a21_665. pub2.

Suitable polyether polyols are for example those of the type recited in DE 26 22 951 B, column 6, line 65 to column 7, line 26, EP-A 0 978 523, page 4, line 45 to page 5, line 14, or WO 2011/069966, page 4, line 20 to page 5, line 23 provided that they conform to the foregoing in respect of functionality and molecular weight. Particularly preferred polyether polyols are addition products of ethylene oxide and/or propylene oxide onto propane-1,2-diol, propane-1,3-diol, glycerol, trimethylolpropane, ethylenediamine and/or pentaerythritol or the polytetramethylene ether glycols having number-average molecular weights of 400 g/mol to 4000 g/mol obtainable by polymerization of tetrahydrofuran according to Angew. Chem. 72, 927 (1960) (https://doi.org/10.1002/ange.19600722402) for example.

Suitable polyester polyols include for example those of the type specified in EP-A 0 978 523, page 5, lines 17 to 47, or EP-A 0 659 792, page 6, lines 32 to 45, provided that they conform to the foregoing in respect of functionality and molecular weight. Particularly preferred polyester polyols are condensation products of polyhydric alcohols, for example ethane-1,2-diol, propane-1,2-diol, diethylene glycol, butane-1,4-diol, hexane-1,6-diol, neopentyl glycol, cyclohexane-1,4-dimethanol, cyclohexane-1,4-diol, perhydrobisphenol, 1,1,1-trimethylolpropane, propane-1,2,3-triol, pentaerythritol and/or sorbitol, with substoichiometric amounts of polybasic carboxylic acids or carboxylic anhydrides, for example succinic acid, adipic acid, sebacic acid, dodecanedioic acid, glutaric anhydride, maleic anhydride, phthalic anhydride, isophthalic acid, terephthalic acid, trimellitic acid, hexahydrophthalic anhydride and/or tetrahydrophthalic anhydride, or those as obtainable in a manner known per se from lactones, for example ε-caprolactone, and simple polyhydric alcohols, for example those mentioned above by way of example, as starter molecules with ring opening.

Suitable polycarbonate polyols include in particular the known-per-se reaction products of dihydric alcohols, for example those as recited by way of example hereinabove in the list of the polyhydric alcohols, with diaryl carbonates, for example diphenyl carbonate, dimethyl carbonate or phosgene. Polycarbonate polyols likewise suitable include those that contain not only carbonate structures but also ester groups. These are, in particular, the polyestercarbonate diols, known per se, of the kind obtainable, for example, according to the teaching of DE-AS 1 770 245 by reaction of dihydric alcohols with lactones, such as in particular ε-caprolactone, and subsequent reaction of the resulting polyester diols with diphenyl or dimethyl carbonate.

Suitable polyacrylate polyols include for example those of the type specified in WO 2011/124710 page 10, line 32 to page 13, line 18 provided that they meet the specifications made above in terms of functionality and molecular weight. Particularly preferred polyacrylate polyols include polymers/copolymers of hydroxyalkyl esters of acrylic acid or methacrylic acid, for example hydroxyethyl (meth)acrylate, hydroxypropyl (meth)acrylate or hydroxybutyl (meth)acrylate, optionally together with acrylic acid alkyl esters and/or methacrylic acid alkyl esters, for example methyl (meth)acrylate, ethyl (meth)acrylate, n-butyl (meth)acrylate, iso-butyl (meth)acrylate, 2-ethylhexyl (meth)acrylate, cyclohexyl (meth)acrylate, isobornyl (meth)acrylate, lauryl (meth)acrylate, styrene or other copolymerizable olefinically unsaturated monomers, for example acrylic acid, methacrylic acid or dimethyl maleate.

Suitable polyols also include for example the known polyacetal polyols obtainable by reaction of simple glycols, for example diethylene glycol, triethylene glycol, 4,4′-dioxethoxydiphenyldimethylmethane (adduct of 2 mol of ethylene oxide onto bisphenol A) or hexanediol, with formaldehyde or else polyacetals prepared by polycondensation of cyclic acetals, for example trioxane.

Polyols further suitable for producing the substantially isocyanate-free uretdione-containing polyaddition compounds A) also include for example those described in EP-A 0 689 556 and EP-A 0 937 110, for example special polyols obtainable by reaction of epoxidized fatty acid esters with aliphatic or aromatic polyols to bring about epoxide ring opening as well as hydroxyl-containing polybutadienes.

Suitable amines for producing the substantially isocyanate-free, uretdione-containing polyaddition compounds A) include for example simple aliphatic and cycloaliphatic monoamines, for example methylamine, ethylamine, n-propylamine, isopropylamine, the isomeric butylamines, pentylamines, hexylamines, and octylamines, n-dodecylamine, n-tetradecylamine, n-hexadecylamine, n-octadecylamine, cyclohexylamine, the isomeric methylcyclohexylamines and also aminomethylcyclohexane, secondary monoamines such as dimethylamine, diethylamine, dipropylamine, diisopropylamine, dibutylamine, diisobutylamine, bis(2-ethylhexyl)amine, N-methyl- and N-ethylcyclohexylamine and also dicyclohexylamine.

Suitable amines also include any desired aliphatic and cycloaliphatic amines having at least two primary and/or secondary amino groups, for example 1,2-diaminoethane, 1,2-diaminopropane, 1,3-diaminopropane, 1,4-diaminobutane, 1,2-diamino-2-methylpropane, 1,5-diaminopentane, 1,3-diamino-2,2-dimethylpropane, 1,6-diaminohexane, 1,5-diamino-2-methylpentane, 1,6-diamino-2,2,4-trimethylhexane, 1,6-diamino-2,4,4-trimethylhexane, 1,7-diaminoheptane, 1,8-diaminooctane, 2,5-diamino-2,5-dimethylhexane, 1,9-diaminononane, 2-methyl-1,8-diaminooctane, 1,10-diaminodecane, 1,11-diaminoundecane, 1,12-diaminododecane, 1,2-diaminocyclopentane, 1,2-diaminocyclohexane, 1-amino-3,3,5-trimethyl-5-aminomethylcyclohexane (isophoronediamine, IPDA), 3(4)-aminomethyl-1-methylcyclohexylamine, 1,3-diamino-2- and/or -4-methylcyclohexane, isopropyl-2,4- and/or 2,6-diaminocyclohexane, 1,3-bis(aminomethyl)cyclohexane, 1,8-p-diaminomenthane, bis(4-aminocyclohexyl)methane, bis(4-amino-3-methylcyclohexyl)methane, bis(4-amino-3,5-dimethylcyclohexyl)methane, bis(4-amino-2,3,5-trimethylcyclohexyl)methane, 1,1-bis(4-aminocyclohexyl)propane, 2,2-bis(4-aminocyclohexyl)propane, 1,1-bis(4-aminocyclohexyl)ethane, 1,1-bis(4-aminocyclohexyl)butane, 2,2-bis(4-aminocyclohexyl)butane, 1,1-bis(4-amino-3-methylcyclohexyl)ethane, 2,2-bis(4-amino-3-methylcyclohexyl)propane, 1,1-bis(4-amino-3,5-dimethylcyclohexyl)ethane, 2,2-bis(4-amino-3,5-dimethylcyclohexyl)propane, 2,2-bis(4-amino-3,5-dimethylcyclohexyl)butane, 2,4-diaminodicyclohexylmethane, 4-aminocyclohexyl-4-amino-3-methylcyclohexylmethane, 4-amino-3,5-dimethylcyclohexyl-4-amino-3-methylcyclohexylmethane, and 2-(4-aminocyclohexyl)-2-(4-amino-3-methylcyclohexyl)methane, m-xylylenediamine, methyliminobispropylamine, iminobispropylamine, bis(6-aminohexyl)amine, N,N-bis(3-aminopropyl)ethylenediamine, 4-aminomethyl-1,8-octanediamine, bis(aminopropyl)piperazine, aminoethylpiperazine, diethylenetriamine, dipropylenetriamine, triethylenetetramine, tetraethylenepentamine, pentaethylenehexamine, heptaethyleneoctamine.

Suitable amines further include amino-functional polyalkylene glycols, for example 1,2-bis(aminoethoxy)ethane, 1,11-diamino-3,6,9-trioxaundecane, 1,13-diamino-4,7,10-trioxatridecane and in particular the amine-functionalized polyalkylene glycols having average molecular weights up to 5000, preferably up to 2000, particularly preferably up to 1000, marketed by Huntsman Corp. under the trade name Jeffamine®.

Optionally also employable for producing the substantially isocyanate-free, uretdione-containing polyaddition compounds A) are sterically hindered aliphatic diamines having two secondary amino groups, for example the reaction products of aliphatic and/or cycloaliphatic diamines with maleic or fumaric esters disclosed in EP-A 0 403 921, the bisadduct of acrylonitrile with isophoronediamine obtainable according to the teaching of EP-A 1 767 559 or the hydrogenation products of Schiff bases obtainable from aliphatic and/or cycloaliphatic diamines and ketones, for example diisopropyl ketone, described in DE-A 19 701 835 for example.

Further suitable polyamines further also include the polyamidoamines, polyimines and/or polyvinylamines known as crosslinker components for epoxy resins.

Finally also suitable for producing the substantially isocyanate-free, uretdione-containing polyaddition compounds A) are amino alcohols, for example 2-aminoethanol, the isomeric aminopropanols and aminobutanols, 3-aminopropane-1,2-diol and 1,3-diamino-2-propanol.

Production of the substantially isocyanate-free, uretdione-containing polyaddition compounds A) from isocyanate-functional uretdione-containing compounds of the abovementioned type employs the recited alcohols and/or amines either individually or as mixtures of at least two such alcohols and/or amines.

Production of the substantially isocyanate-free, uretdione-containing polyaddition compound A) may be carried out by various methods, for example the processes known from the literature for producing polyuretdione compositions such as e.g. are described for example in WO 99/11690 and WO 2011/115669.

Optionally co-usable in addition to the isocyanate-functional uretdione-containing compounds obtained by oligomerization are further monomeric isocyanates of the abovementioned type and/or oligomeric polyisocyanates, preferably those having an isocyanurate, biuret, iminooxadiazinedione, allophanate and/or urethane structure, in an amount of up to 30% by weight based on the total weight of all reaction partners (comprising the isocyanate-functional uretdione-containing compounds, alcohols and/or amines).

The reaction is preferably carried out while maintaining an equivalent ratio of isocyanate groups to isocyanate-reactive groups of 1:0.9 to 0.5:1, preferably of 1:0.95 to 0.7:1, particularly preferably of 1:1 to 0.9:1.

In a further preferred embodiment component A) is polyaddition compounds obtained by reaction of isocyanate-functional, uretdione-containing compounds with at least difunctional polyols in the molecular weight range 62 to 22 000 and optionally monoalcohols while maintaining an equivalent ratio of isocyanate groups to isocyanate-reactive groups of 1.0:0.9 to 0.5:1.

The reaction may be performed solventlessly or in a suitable solvent inert towards isocyanate groups.

Suitable solvents for producing the polyaddition compounds A2) especially include those inert towards the isocyanate groups of the compound A1), for example the known customary aprotic coatings solvents, for example ethyl acetate, isopropyl acetate, butyl acetate, isobutyl acetate, amyl acetate, 2-ethylhexyl acetate, ethylene glycol monomethyl ether acetate, ethylene glycol monoethyl ether acetate, ethylene glycol monobutyl ether acetate, 1-methoxyprop-2-yl acetate, 3-methoxy-n-butyl acetate, acetone, diethyl ketone, 2-butanone, 4-butyl-2-pentanone, diisobutyl ketone, cyclohexanone, cyclohexane, toluene, xylene, chlorobenzene, dichlorobenzene, petroleum spirit, aromatics having a relatively high degree of substitution, as commercially available, for example, under the Solventnaphtha, Solvesso, Isopar®, Nappar® (Deutsche EXXON CHEMICAL GmbH, Cologne, DE) and Shellsol® (Deutsche Shell Chemie GmbH, Eschborn, DE) names, but also solvents such as propylene glycol diacetate, diethylene glycol dimethyl ether, dipropylene glycol dimethyl ether, diethylene glycol ethyl and butyl ether acetate, ethyl ethoxypropionate, propylene carbonate, N-methylpyrrolidone and N-methylcaprolactam, dioxane, tetrahydrofuran or any desired mixtures of such solvents.

The reaction of the isocyanate-functional uretdione-containing compounds with the alcohols and/or amines to afford the uretdione-containing polyaddition compounds A) may be carried out uncatalyzed. However, for the purposes of reaction acceleration it is also possible to employ customary catalysts known from polyurethane chemistry. Examples include tertiary amines, for example triethylamine, tributylamine, dimethylbenzylamine, diethylbenzylamine, pyridine, methylpyridine, dicyclohexylmethylamine, dimethylcyclohexylamine, N,N,N′,N′-tetramethyldiaminodiethyl ether, bis(dimethylaminopropyl)urea, N-methyl- or N-ethylmorpholine, N-cocomorpholine, N-cyclohexylmorpholine, N,N,N′,N′-tetramethylethylenediamine, N,N,N′,N′-tetramethyl-1,3-butanediamine, N,N,N′,N′-tetramethyl-1,6-hexanediamine, pentamethyldiethylenetriamine, N-methylpiperidine, N-dimethylaminoethylpiperidine, N,N′-dimethylpiperazine, N-methyl-N′-dimethylaminopiperazine, 1,8-diazabicyclo(5.4.0)undec-7-ene, 1,2-dimethylimidazole, 2-methylimidazole, N,N-dimethylimidazole-p-phenylethylamine, 1,4-diazabicyclo-(2,2,2)-octane, bis(N,N-dimethylaminoethyl) adipate; alkanolamine compounds, for example triethanolamine, triisopropanolamine, N-methyl- and N-ethyldiethanolamine, dimethylaminoethanol, 2-(N,N-dimethylaminoethoxy)ethanol, N,N′,N″-tris(dialkylaminoalkyl)hexahydrotriazines, for example N,N′,N″-tris(dimethylaminopropyl)-s-hexahydrotriazine and/or bis(dimethylaminoethyl) ether; metal salts, for example inorganic and/or organic compounds of iron, lead, bismuth, zinc and/or tin in customary oxidation states of the metal, for example iron(II) chloride, iron(III) chloride, bismuth(III) acetate, bismuth(III) 2-ethylhexanoate, bismuth(III) octoate, bismuth(III) neodecanoate, zinc chloride, zinc 2-ethylcaproate, tin(II) octoate, tin(II) ethylcaproate, tin(II) palmitate, dibutyltin(IV) dilaurate (DBTL), dibutydilauryltin mercaptide or lead octoate; amidines, for example 2,3-dimethyl-3,4,5,6-tetrahydropyrimidine; tetraalkylammonium hydroxides, for example tetramethylammonium hydroxide; alkali metal hydroxides, for example sodium hydroxide, and alkali metal alkoxides, for example sodium methoxide and potassium isopropoxide, and alkali metal salts of long-chain fatty acids having 10 to 20 carbon atoms and optionally pendant OH groups.

Preferred catalysts are tertiary amines, bismuth and tin compounds of the abovementioned type.

Uretdione-comprising component A) is preferably substantially isocyanate-free polyaddition compounds of the recited type obtainable by reaction of isocyanate-functional uretdione-containing compounds with alcohols and/or amines.

Uretdione-comprising components A) employed in the process according to the invention are very particularly preferably completely free from isocyanate groups. However, in the context of the present publication the term “substantially isocyanate-free” is to be understood as meaning that following its production component A) may still comprise small residual amounts of isocyanate groups. “Substantially isocyanate-free” is preferably to be understood as including uretdione-containing polyaddition compounds A) which in solvent-free form have a content of free isocyanate groups of less than 2% by weight, preferably of less than 1% by weight and particularly preferably of less than 0.5% by weight.

The present invention preferably provides a process for producing isocyanurate-containing compounds comprising reacting
A) at least one component which comprises at least one uretdione group and in solvent-free form has a content of free isocyanate groups of less than 2% by weight, preferably of less than 1% by weight and particularly preferably of less than 0.5% by weight in the presence of
B) at least one catalyst containing a structural element of general formulae (I) and/or (II)

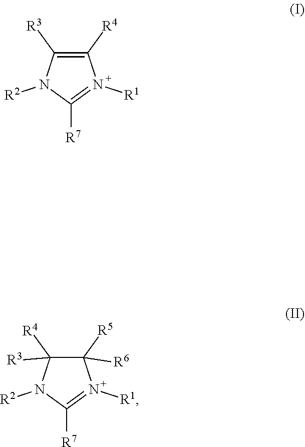

in which
R¹, R², R³, R⁴, R⁵ and R⁶ independently of one another stand for identical or different radicals which represent saturated or unsaturated, linear or branched, aliphatic, cycloaliphatic, araliphatic or aromatic organic radicals having 1 to 18 carbon atoms which are substituted or unsubstituted and/or have heteroatoms in the chain, wherein the radicals may also in combination with one another optionally together with a further heteroatom form rings having 3 to 8 carbon atoms which may optionally be further substituted, wherein
R³, R⁴, R⁵ and R⁶ may independently of one another also represent hydrogen and
R⁷ represents hydrogen or a carbon/late anion (COO⁻).

It is alternatively or in addition preferable when the reaction of A) at least one substantially isocyanate-free component which comprises at least one uretdione group is performed in the presence of B) at least one catalyst containing a structural element of general formulae (I) and/or (II) in the absence of hydroxy- or mercapto-functional compounds.

In the process according to the invention the substantially isocyanate-free, uretdione-comprising component A) is reacted with an imidazolium cation and/or imidazolinium cation in the presence of at least one salt-type catalyst B).

Compounds suitable as catalysts B) are also known as imidazolium- and imidazolinium-type ionic liquids and are employed for example as solvents in chemical synthesis. Processes for their production are described for example in Chem. Rev. 99, 8, 2071-2084 and WO 2005/070896.

The catalysts B) are salt-type compounds containing a structural element of general formulae (I) or (II)

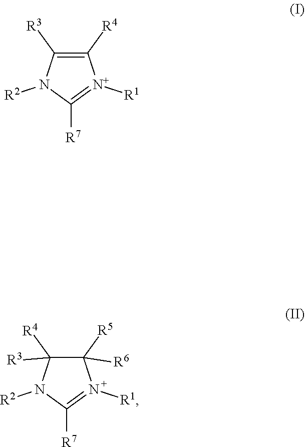

in which
R¹, R², R³, R⁴, R⁵ and R⁶ independently of one another stand for identical or different radicals which represent saturated or unsaturated, linear or branched, aliphatic, cycloaliphatic, araliphatic or aromatic organic radicals having 1 to 18 carbon atoms, which are substituted or unsubstituted and/or have heteroatoms in the chain, wherein the radicals may also in combination with one another optionally together with a further heteroatom form rings having 3 to 8 carbon atoms which may optionally be further substituted,
R³, R⁴, R⁵ and R⁶ may independently of one another also represent hydrogen and
R⁷ represents hydrogen or a carboxylate anion (COO⁻).

Preferred catalysts B) are salt-type compounds containing a structural element of general formulae (I) or (II), in which
R¹ and R² independently of one another stand for identical or different radicals which represent saturated or unsaturated, linear or branched, aliphatic, cycloaliphatic, araliphatic or aromatic organic radicals which have 1 to 12 carbon atoms, are substituted or unsubstituted and/or have heteroatoms in the chain,
R³, R⁴, R⁵ and R⁶ represent hydrogen and wherein
R⁷ represents hydrogen or a carboxylate anion (COO⁻).

Particularly preferred catalysts B) are salt-type compounds containing a structural element of general formulae (I) or (II), in which
R¹ and R² independently of one another stand for identical or different radicals which represent saturated or unsaturated, linear or branched, aliphatic organic radicals having 1 to 12 carbon atoms,
R³, R⁴, R⁵ and R⁶ represent hydrogen and
R⁷ represents hydrogen or a carboxylate anion (COO⁻).

Suitable catalysts of general formula (I) include for example those containing a cation selected from 1,3-dimethylimidazolium, 1-methyl-3-ethylimidazolium, 1-methyl-3-propylimidazolium, 1-methyl-3-butylimidazolium, 1-methyl-3-pentylimidazolium, 1-methyl-3-hexylimidazolium, 1-methyl-3-octylimidazolium, 1-methyl-3-nonylimidazolium, 1-methyl-3-decylimidazolium, 1-decyl-3-methylimidazolium, 1-methyl-3-benzylimidazolium, 1-methyl-3-(3-phenylpropyl)imidazolium, 1-ethyl-3-methylimidazolium (EMIM), 1-isopropyl-3-methylimidazolium, 1-butyl-3-methylimidazolium (BMIM), 1-hexyl-3-methylimidazolium, 1-heptyl-3-methylimidazolium, 1-(2-ethyl)hexyl-3-methylimidazolium (OMIM), 1,3-bis(tert-butyl)imidazolium, 1,3-bis(2,4,6-trimethylphenyl)imidazolium or 1,3-dimethylbenzimidazolium.

Suitable catalysts of general formula (II) include for example those containing a cation selected from 1,3-dimethylimidazolinium, 1-ethyl-3-methylimidazolinium, 1-butyl-3-methylimidazolium-1,3-bis-(2,6-diisopropylphenyl)imidazolinium or 1,3-bis(2,4,6-trimethylphenyl)imidazolinium-1-(1-adamantyl)-3-(2,4,6-trimethylphenyhimidazolinium,1,3-diphenyl-4,4,5,5-tetramethylimidazolinium, 1,3-di-o-tolyl-4,4,5,5-tetramethylimidazolinium.

As a counterion to the imidazolium and imidazolinium cations the catalysts B) employed in the process according to the invention contain any inorganic and/or organic anions such as for example halide, sulfate, hydroxysulfate, sulfite, nitrate, carbonate, hydrogencarbonate, arylsulfonate, alkylsulfonate, trifluoromethylsulfonate, alkylsulfate, phosphate, dialkylphosphate, hexafluorophosphate, trifluoromethylborate, tetrafluoroborate, bis(trifluoromethylsulfonyl)imide, dicyanamide and/or carboxylate anions.

The counterion to the imidazolium and imidazolinium cations may in addition also be a carboxylate group (COO⁻) bonded directly to the imidazolium cation as R⁷ of general formula (I), wherein the catalyst B) is in the case in the form of a zwitterionic structure.

Suitable catalysts B) for the process according to the invention include for example 1,3-dimethylimidazolium chloride, 1,3-dimethylimidazolium 2-carboxylate, 1,3-dimethylimidazolium dimethylphosphate, 1-ethyl-3-methylimidazolium chloride, 1-ethyl-3-methylimidazolium bromide, 1-ethyl-3-methylimidazolium iodide, 1-ethyl-3-methylimidazolium nitrate, 1-ethyl-3-methylimidazolium hydrogencarbonate, 1-ethyl-3-methylimidazolium methanesulfonate, 1-ethyl-3-methylimidazolium trifluoromethanesulfonate, 1-ethyl-3-methylimidazolium trifluoro(trifluoromethyl)borate, 1-ethyl-3-methylimidazolium hydrogensulfate, 1-ethyl-3-methylimidazolium ethylsulfate, 1-ethyl-3-methylimidazolium dicyanamide, 1-ethyl-3-methylimidazolium tetrafluoroborate, 1-ethyl-3-methylimidazolium diethylphosphate, 1-ethyl-3-methylimidazolium hexafluorophosphate, 1-ethyl-3-methylimidazolium bis(trifluoromethanesulfonyl)imide, 1-ethyl-3-methylimidazolium 2-carboxylate, 1-ethyl-3-methylimidazolium acetate, 1-ethyl-3-methylimidazolium (L)-(+)-lactate, 1-methyl-3-propylimidazolium iodide, 1,3-diisopropyl-4,5-dimethylimidazolium 2-carboxylate, 1-butyl-3-methylimidazolium chloride, 1-butyl-3-methylimidazolium bromide, 1-butyl-3-methylimidazolium iodide, 1-butyl-3-methylimidazolium trifluoromethanesulfonate, 1-butyl-3-methylimidazolium ethylsulfate, 1-butyl-3-methylimidazolium n-octylsulfate, 1-butyl-3-methylimidazolium dicyanamide, 1-butyl-3-methylimidazolium trifluoro(trifluoromethyl)borate, 1-butyl-3-methylimidazolium tetrafluoroborate, 1-butyl-3-methylimidazolium dibutylphosphate, 1-butyl-3-methylimidazolium hexafluorophosphate, 1-butyl-3-methylimidazolium 2-carboxylate, 1-butyl-3-methylimidazolium acetate, 1-butyl-3-methylimidazolium bis(trifluoromethanesulfonyl)imide, bis(tert-butyl)imidazolium 2-carboxylate, 1-hexyl-3-methylimidazolium chloride, 1-hexyl-3-methylimidazolium bromide, 1-hexyl-3-methylimidazolium tetrafluoroborate, 1-hexyl-3-methylimidazolium bis(trifluoromethanesulfonyl)imide, 1-hexyl-3-methylimidazolium hexafluorophosphate, 1-methyl-3-n-octylimidazolium bromide, 1-methyl-3-n-octylimidazolium chloride, 1-methyl-3-n-octylimidazolium hexafluorophosphate, 1-decyl-3-methylimidazolium bis(trifluoromethansulfonyl)imide, 1,3-dimethylimidazolinium chloride, 1,3-dimethylimidazolinium 2-carboxylate, 1,3-dimethylimidazolinium acetate, 1-ethyl-3-methylimidazolinium chloride, 1-ethyl-3-methylimidazolinium 2-carboxylate, 1-ethyl-3-methylimidazolinium acetate, 1-butyl-3-methylimidazolinium 2-carbon/late, 1,3-bis(2,6-diisopropylphenyl)imidazolinium chloride or 1,3-bis(2,4,6-trimethylphenyl)imidazolinium-1-(1-adamantyl)-3-(2,4,6-trimethylphenyl)imidazolinium chloride and/or 1,3-diphenyl-4,4,5,5-tetramethylimidazolinium chloride.

Particularly preferred catalysts B) are imidazolium salts of the recited type with carbon/late anions, very particularly preferably 1,3-dimethylimidazolium 2-carbon/late, 1-ethyl-3-methylimidazolium 2-carboxylate, 1-ethyl-3-methylimidazolium acetate, 1-butyl-3-methylimidazolium 2-carboxylate and/or 1-butyl-3-methylimidazolium acetate.

In a further preferred embodiment the catalysts B) are employed in the process according to the invention either individually or as mixtures of at least two such catalysts in an amount of 0.001% to 15% by weight, preferably 0.005% to 12% by weight, particularly preferably 0.01% to 10% by weight, based on the total weight of components A) and B), excluding any solvents and auxiliary or additive substances present in these components.

The process according to the invention is exceptionally suitable for producing isocyanurate-crosslinked polyurethane plastics from substantially isocyanate-free, uretdione-comprising starting component and is used for this purpose.

The invention therefore likewise provides compositions, preferably coating formulations, containing at least one isocyanate-free polyaddition compound A) of the recited type obtainable by reaction of isocyanate-functional uretdione-containing compounds with alcohols and/or amines, at least one catalyst B) having an imidazolium or imidazolinium structure which comprises a structural element of general formulae (I) and/or (II) according to any of claims 1, 5 to 8 and optionally further auxiliary and additive substances. Preference is given to a composition containing at least one polyaddition compound A) obtainable by reaction of isocyanate-functional uretdione-containing compounds with alcohols and/or amines and at least one catalyst B) having an imidazolium or imidazolinium structure which comprises a structural element of general formulae (I) and/or (II) according to any of claims 1, 5 to 8 and optionally further auxiliary and additive substances, wherein the polyaddition compound A) in solvent-free form has a content of free isocyanate groups of less than 2% by weight, preferably of less than 1% by weight and particularly preferably of less than 0.5% by weight.

The process according to the invention is preferably used for producing coating formulations.

In a further preferred embodiment the performance of the process according to the invention and curing of the compositions according to the invention are performed in the temperature range of 0° C. to 230° C., preferably of 40° C. to 200° C., particularly preferably of 70° C. to 180° C. and very particularly preferably of 80° C. to 160° C., preferably over a period of 1 minute up to 12 hours.

Under these conditions the uretdione groups originally present in component A) generally undergo complete reaction to form isocyanurate groups. As demonstrated by IR spectroscopy analysis no free isocyanate groups are formed over the entire reaction time. A direct reaction of uretdione to isocyanurate groups is concerned.

The invention further provides for the use of at least one composition according to the invention for producing polyurethane plastics. In addition, the invention further provides for the use of at least one composition according to the invention for producing coating formulations.

Substrates contemplated for the coatings formulated using the compositions according to the invention include any desired substrates, for example, metal, wood, glass, stone, ceramic materials, concrete, rigid and flexible plastics, textiles, leather, and paper, which prior to coating may optionally also be provided with customary primers.

The invention further provides coating formulations containing at least one composition according to the invention and a substrate coated with an optionally heat-cured coating formulation according to the invention.

The coating formulations formulated with the compositions according to the invention which may optionally be admixed with the customary auxiliary and additive substances known to those skilled in the art from coatings technology, for example solvents, UV stabilizers, antioxidants, leveling agents, rheological additives, slip additives, dyes, matting agents, flame retardants, hydrolysis inhibitors, microbicides, algicides, water scavengers, thixotropic agents, wetting agents, deaerating agents, adhesion promoters, fillers and/or pigments, afford films having good coating properties under the recited curing conditions.

The invention likewise provides polyurethane plastics, preferably shaped articles, crosslinked via isocyanurate groups obtainable or obtained from an optionally heat-cured composition according to the invention or coatings obtainable through use of the above-described coating formulations.

### EXAMPLES

All percentages are based on weight, unless stated otherwise.

NCO contents were determined titrimetrically in accordance with DIN EN ISO 11909:2007-05.

All viscosity measurements were taken with a Physica MCR 51 rheometer from Anton Paar Germany GmbH (DE) according to DIN EN ISO 3219:1994-10 at a shear rate of 250 s⁻¹.

Residual monomer contents were measured in accordance with DIN EN ISO 10283:2007-11 by gas chromatography with an internal standard.

The compositions of the uretdione model compounds were determined by gel permeation chromatography based on DIN 55672-1:2016-03 (gel permeation chromatography (GPC)—part 1: tetrahydrofuran (THF) as eluent) with the modification that a flow rate of 0.6 ml/min rather than 1.0 ml/min was used. The proportions of the different oligomers from the chromatograms in area % which were determined with software assistance were in each case approximately equated with proportions in % by weight. Konig pendulum damping was determined in accordance with DIN EN ISO 1522:2007-04 on glass plates.

The uretdione reaction products formed during curing of the compositions according to the invention were determined using proton-decoupled ¹³C-NMR spectra (recorded using CDCl₃ solvent on a Bruker DPX-400 instrument). The structural elements relevant to the present invention have the following chemical shifts (in ppm): uretdione: 157.1; urethane: 156.3; isocyanurate: 148.4.

IR spectra were recorded using the Bruker Alpha-P IR FT-IR spectrometer. A matrix FM from Bruker with a 3 mm diamond head probe was used for in-situ IR measurements. The spectra were analyzed using Bruker OPUS 7.0 spectroscopy software.

Solvent resistance was determined using xylene as a typical coatings solvent. To this end a small amount of the solvent was added to a test tube and provided with a cotton pad at the opening so that an atmosphere saturated with xylene was formed inside the test tube. The test tube was subsequently placed with the cotton pad on the coating surface and remained there for 5 minutes. Once the solvent had been wiped off, the film was examined for destruction/softening/loss of adhesion. (0=no change, 5=film destroyed)

Starting Compounds

Production of an HDI Uretdione Model Compound (HDI-UD1)

### Production of 1,3-bis(6-isocyanatohexyl)-1,3-diazetidine-2,4-dione

According to the process described in example 1 of EP-A 0 789 017 1,3-bis(6-isocyanatohexyl)-1,3-diazetidine-2,4-dione (ideal bis(6-isocyanatohexyl)uretdione) was produced by tributylphosphine-catalyzed oligomerization of 1,6-diisocyanatohexane (HDI) and subsequent distillative workup.
NCO content: 25.0%
Monomeric HDI: <0.03%
Viscosity (23° C.): 28 mPas

Analysis by gel permeation chromatography (GPC) reveals the following composition:

| | | |
|---|---|---|
| HDI uretdione (n = 2): | 99.2% | (according to GPC) |
| HDI isocyanurate (n = 3): | 0.4% | (according to GPC) |
| higher oligomers: | 0.4% | (according to GPC) |

### Production of the dimethylurethane of bis(6-isocyanatohexyl)uretdione

10 g (0.0595 eq) of the above-described HDI uretdione were dissolved in 30 ml of dichloromethane, admixed with 2 g (0.0625 mol) of methanol and stirred at 40° C. under dry nitrogen until isocyanate was no longer detectable by IR spectroscopy after 8 h. Dichloromethane and excess methanol were then removed using a rotary evaporator. The dimethylurethane of bis(6-isocyanatohexyl)uretdione (HDI-UD1) was obtained as a colorless solid. There were no longer any free isocyanate groups detectable by IR spectroscopy (no isocyanate absorption band at 2270 cm⁻¹).
Uretdione group content: 21.0% (calculated as C₂N₂O₂, molecular weight 84)

Production of an HDI Polyuretdione (HDI-UD2)

1000 g (5.95 eq) of the above-described ideal bis(6-isocyanatohexyl) uretdione (NCO content: 25.0%) were dissolved in 800 g of butyl acetate, 4.6 g (0.2% by weight) of a 10% solution of dibutyltin dilaurate (DBTL) in butyl acetate were added and the mixture was heated to 60° C. under dry nitrogen and with stirring. A mixture of 347.5 g (4.76 eq) of 2,2,4-trimethylpentane-1,3-diol and 154.7 g (1.19 eq) of 2-ethyl-1-hexanol was added dropwise to this solution over 2 hours. After a stirring time of 48 hours at 60° C. the NCO content was <0.1%. A practically colorless solution of an HDI polyuretdione crosslinker (HDI-UD2) was obtained.
NCO content: <0.1%
Uretdione group content: 10.8% (calculated as C₂N₂O₂, molecular weight 84)
Uretdione functionality: 5 (calculated)
Solids content: about 65%

Viscosity (23° C.): 1400 mPas

### Production of a PDI uretdione model compound (PDI-UD1)

### Production of 1,3-bis(5-isocyanatopentyl)-1,3-diazetidine-2,4-dione

According to the process described in example 1 of EP-A 0 789 017 1,3-bis(5-isocyanatopentyl)-1,3-diazetidine-2,4-dione (ideal bis(5-isocyanatopentyl)uretdione) was produced by tributylphosphine-catalyzed oligomerization of 1,5-diisocyanatopentane (PDI) instead of 1,6-diisocyanatohexane (HDI) and subsequent distillative workup.
NCO content: 27.3%
Monomeric PDI: 0.03%
Viscosity (23° C.): 22 mPas

Analysis by gel permeation chromatography (GPC) reveals the following composition:

| | | |
|---|---|---|
| HDI uretdione (n = 2): | 98.7% | (according to GPC) |
| HDI isocyanurate (n = 3): | 0.7% | (according to GPC) |
| higher oligomers: | 0.6% | (according to GPC) |

### Production of the dimethyl urethane of bis(5-isocyanatopentyl)uretdione (PDI-UD1)

10 g (0.065 eq) of the above-described PDI uretdione were dissolved in 30 ml of dichloromethane, admixed with 2 g (0.068 mol) of methanol and stirred at 40° C. under dry nitrogen until isocyanate was no longer detectable by IR spectroscopy after 8 h. Dichloromethane and excess methanol were then removed using a rotary evaporator. The dimethylurethane of bis(5-isocyanatopentyl)uretdione (PDI-UD1) was obtained as a colorless solid. There were no longer any free isocyanate groups detectable by IR spectroscopy (no isocyanate absorption band at 2270 cm⁻¹).

Uretdione group content: 22.3% (calculated as C₂N₂O₂, molecular weight 84)

Catalysts
1-Ethyl-3-methylimidazolium acetate (97%), Sigma-Aldrich Chemie GmbH, Munich, DE
1-Ethyl-3-methylimidazolium-(L)-(+) lactate (95%), Sigma-Aldrich Chemie GmbH, Munich, DE
1-Ethyl-3-methylimidazolium 2-carboxylate, produced by the process described in Chem. Eur. J. 2016, 22, 16292-16303
1-Ethyl-3-methylimidazolium hydrogencarbonate (96%), Alfa Chemistry, New York, USA

### Example 1

In an oven-dried and pressure-resistant reaction vial 70 mg (0.40 mmol) of 1-ethyl-3-methylimidazolium acetate together with 800.0 mg (2.00 mmol) of the HDI uretdione model compound (HDI-UD1) were dissolved in 10.0 ml of absolute tetrahydrofuran (THF). The reaction vessel was closed and the contents then stirred at 80° C. for one hour. After removal of the solvent in high vacuum the residue was extracted with 30 mL of water and 50 mL of ethyl acetate. The aqueous phase was separated off and extracted a further three times with 50 ml of ethyl acetate in each case. The combined organic phases were washed with 100 ml of saturated NaCl solution, dried over MgSO₄, filtered and the solvent removed under vacuum. Obtained as product in quantitative yield (800 mg) was a white solid which according to ¹³C NMR was the trimethylurethane of tris(6-isocyanatohexyl) isocyanurate. Uretdione signals were no longer detectable. In situ IR measurements did not indicate the presence of free isocyanate groups at any time during the reaction.

### Example 2

In an oven-dried and pressure-resistant reaction vial 8.4 mg (0.04 mmol) of 1-ethyl-3-methylimidazolium-(L)-(+) lactate together with 80.0 mg (0.20 mmol) of the HDI uretdione model compound (HDI-UD1) were dissolved in 1.0 ml of absolute tetrahydrofuran (THF). The reaction vessel was closed and the contents then stirred at 80° C. for one hour. Obtained as product after removal of the solvent under high vacuum was a pale yellow oil which according to ¹³C NMR was the trimethyl urethane of tris(6-isocyanatohexyl) isocyanurate. Uretdione signals were no longer detectable. In situ IR measurements did not indicate the presence of free isocyanate groups at any time during the reaction.

### Example 3

In an oven-dried and pressure-resistant reaction vial 6.16 mg (0.04 mmol) of 1-ethyl-3-methylimidazolium 2-carboxylate together with 80.0 mg (0.20 mmol) of the HDI uretdione model compound (HDI-UD1) were dissolved in 1.0 ml of absolute tetrahydrofuran (THF). The reaction vessel was closed and the contents then stirred at 80° C. for one hour. Obtained as product after removal of the solvent under high vacuum was a pale yellow oil which according to ¹³C NMR was the trimethyl urethane of tris(6-isocyanatohexyl) isocyanurate. Uretdione signals were no longer detectable. In situ IR measurements did not indicate the presence of free isocyanate groups at any time during the reaction.

### Example 4

In an oven-dried and pressure-resistant reaction vial 71.7 mg (0.40 mmol) of 1-ethyl-3-methylimidazolium hydrogencarbonate together with 800 mg (2.00 mmol) of the HDI uretdione model compound (HDI-UD1) were dissolved in 10 ml of absolute tetrahydrofuran (THF). The reaction vessel was closed and the contents then stirred at 80° C. for one hour. The solvent was then removed under high vacuum and the obtained crude product was worked up by the process described in example 1. Obtained as product in quantitative yield (800 mg) was a white solid which according to ¹³C NMR was the trimethyl urethane of tris(6-isocyanatohexyl) isocyanurate. Uretdione signals were no longer detectable. In situ IR measurements did not indicate the presence of free isocyanate groups at any time during the reaction.

### Example 5

In an oven-dried and pressure-resistant reaction vial 6.16 mg (0.04 mmol) of 1-ethyl-3-methylimidazolium 2-carboxylate together with 80.0 mg (0.20 mmol) of the HDI uretdione model compound (HDI-UD1) were dissolved in 1.0 ml of absolute tetrahydrofuran (THF). The reaction vessel was closed and the contents then stirred at 80° C. for one hour. Obtained as product after removal of the solvent under high vacuum was a pale yellow oil which according to ¹³C NMR was the trimethyl urethane of tris(6-isocyanatohexyl) isocyanurate. Uretdione signals were no longer detectable. In situ IR measurements did not indicate the presence of free isocyanate groups at any time during the reaction.

### Example 6

In an oven-dried and pressure-resistant reaction vial 0.05 g (0.3 mmol) of 1-ethyl-3-methylimidazolium acetate together with 0.53 g (1.4 mmol) of the PDI uretdione model compound (PDI-UD1) were dissolved in 10.6 ml of absolute tetrahydrofuran (THF). The reaction vessel was closed and the contents then stirred at 80° C. for one hour. Obtained as product after removal of the solvent under high vacuum was a light yellow oil which according to ¹³C NMR was the trimethyl urethane of tris(5-isocyanatohexyl) isocyanurate. Uretdione signals were no longer detectable. In situ IR measurements did not indicate the presence of free isocyanate groups at any time during the reaction.

### Example 7 (Inventive and Comparative)

100 g (0.128 eq) of the 65% solution of the HDI polyuretdione crosslinker (HDI-UD2) in butyl acetate were mixed with 3 g (0.018 mol) of 1-ethyl-3-methylimidazolium acetate as catalyst to afford a coating formulation and applied to a degreased glass plate using a film applicator in applied film thickness of 150 μm.

After flashing off at room temperature for 15 minutes the coating was cured at 100° C. over 40 min. This afforded a hard, elastic and completely transparent coating having a pendulum hardness of 135 s and a xylene resistance of 1-2.

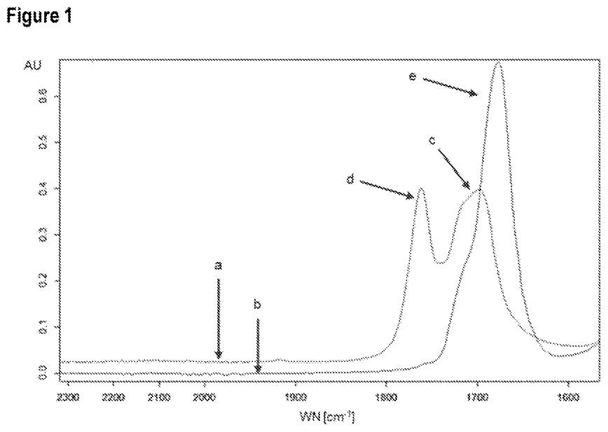

FIG. 1 shows the IR spectrum (AU: absorption units, WN: wavenumber) of the coating formulation before (a) and after (b) curing. It is apparent that the uretdione groups (d) (band at about 1780 cm⁻¹) originally present in addition to urethane groups (c) have completely disappeared in the cured coating film. Instead, an isocyanurate band (e) appears at about 1670 cm⁻¹. Isocyanate groups (band at about 2270 cm⁻¹) are not detectable.

1. A process for producing isocyanurate-containing compounds comprising reaction of
A) at least one substantially isocyanate-free component comprising at least one uretdione group in the presence of
B) at least one catalyst containing a structural element of general formulae (I) and/or (II) 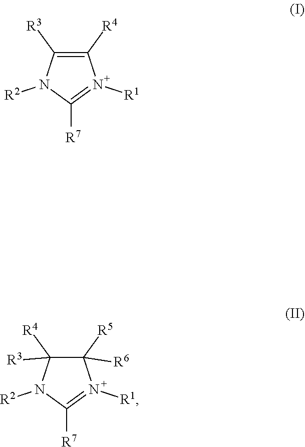
in which
R¹, R², R³, R⁴, R⁵ and R⁶ independently of one another stand for identical or different radicals which represent saturated or unsaturated, linear or branched, aliphatic, cycloaliphatic, araliphatic or aromatic organic radicals having 1 to 18 carbon atoms which are substituted or unsubstituted and/or have heteroatoms in the chain, wherein the radicals may also in combination with one another optionally together with a further heteroatom form rings having 3 to 8 carbon atoms which may optionally be further substituted, wherein
R³, R⁴, R⁵ and R⁶ may independently of one another also represent hydrogen and
R⁷ represents hydrogen or a carboxylate anion (COO⁻).

2. The process as claimed in claim 1, characterized in that component A) is a polyaddition compounds obtained by oligomerization of monomeric isocyanates and/or by reaction of isocyanate-functional uretdione-containing compounds with alcohols and/or amines.

3. The process as claimed in claim 2, characterized in that component A) is a uretdione-containing compounds based on one selected from the group consisting of PDI, HDI, IPDI, NBDI, XDI, and H₁₂-MDI.

4. The process as claimed in claim 2, characterized in that component A) is a polyaddition compounds obtained by reaction of isocyanate-functional, uretdione-containing compounds with at least difunctional polyols in the molecular weight range 62 to 22 000 and optionally monoalcohols while maintaining an equivalent ratio of isocyanate groups to isocyanate-reactive groups of 1.0:0.9 to 0.5:1.

5. The process as claimed in claim 1, characterized in that component B) is a compounds of general formulae (I) and/or (II), in which
R¹ and R² independently of one another are identical or different radicals which represent saturated or unsaturated, linear or branched, aliphatic, cycloaliphatic, araliphatic or aromatic organic radicals which have 1 to 12 carbon atoms, are substituted or unsubstituted and/or have heteroatoms in the chain,
R³, R⁴, R⁵ and R⁶ represent hydrogen and wherein
R⁷ represents hydrogen or a carboxylate anion (COO⁻).

6. The process as claimed in claim 1, characterized in that component B) is a compounds of general formulae (I) and/or (II), in which
R¹ and R² independently of one another are identical or different radicals which represent saturated or unsaturated, linear or branched, aliphatic organic radicals having 1 to 12 carbon atoms,
R³, R⁴, R⁵ and R⁶ represent hydrogen and
R⁷ represents hydrogen or a carboxylate anion (COO⁻).

7. The process as claimed in claim 1, characterized in that catalyst B) is an imidazolium salts of general formula (I) where R⁷ represents a carboxylate anion.

8. The process as claimed in claim 1, characterized in that catalyst B) is selected from the group consisting of 1,3-dimethylimidazolium 2-carboxylate, 1-ethyl-3-methylimidazolium 2-carboxylate, 1-ethyl-3-methylimidazolium acetate, 1-butyl-3-methylimidazolium 2-carboxylate, and/or 1-butyl-3-methylimidazolium acetate.

9. The process as claimed in claim 1, characterized in that component B) is present in an amount of 0.001% to 15% by weight, based on the total weight of components A) and B), excluding any solvents, auxiliaries or additives present in these components.

10. A composition containing at least one substantially isocyanate-free polyaddition compound A) obtainable by reaction of isocyanate-functional uretdione-containing compounds with alcohols and/or amines and at least one catalyst B) having an imidazolium or imidazolinium structure which comprises a structural element of general formulae (I) and/or (II) as claimed in claim 1, and optionally further auxiliary and additive substances.

11. The use of compositions as claimed in claim 10 for producing polyurethane plastics or coating formulations.

12. A polyurethane plastic obtained from an optionally heat-cured composition as claimed in claim 10.

13. A shaped article made of a polyurethane plastic as claimed in claim 12.

14. A coating formulation containing compositions as claimed in claim 10.

15. A substrate coated with a heat-cured coating formulation as claimed in claim 14.
